(19) United States
(12) Patent Application Publication
(10) Pub. No.: US 2025/0331680 A1
(43) Pub. Date: Oct. 30, 2025

(54) Air fryer tray stack

(71) Applicant: Coppice Alupack Limited, Birmingham (GB)

(72) Inventors: Nick Brown, Birmingham (GB); Leon Elston, Birmingham (GB)

(21) Appl. No.: 19/036,683

(22) Filed: Jan. 24, 2025

(30) Foreign Application Priority Data
Apr. 25, 2024 (GB) 2405848.9

(51) Int. Cl. A47J 37/06

(52) U.S. Cl. CPC A47J 37/0641

(57) ABSTRACT

A multilayer food tray assembly suitable for use in an air fryer wherein the food tray assembly comprises two or more food trays and a frame wherein the frame provides a tray support wherein each tray has a lip for mounting on a tray support wherein at least one tray is a narrow tray which is narrower than the frame whereby a ventilation slot is formed between the narrow tray and the frame.

The present invention relates to food packaging suitable for use principally in an air fryer as well as in a microwave oven, fan oven, and/or a convection oven.

Air fryers are becoming a more popular domestic kitchen cooking device. They are versatile as they can be used to cook a huge range of different foods. They work by circulating hot air to create a ‘fried’ finish on food, using little to no oil. Due to their compact size and ability to heat up quickly, they are more energy efficient than a standard oven for cooking smaller quantities of food. This has made them popular after the recent surge in the cost of energy. They are also easy to store due to their size and space-saving features such as cord storage.

Currently food packaging is designed to be suitable for use in conventional ovens or microwaves. Air fryers work in a different way and pose challenges due to their compact size.

A way of ameliorating these problems has been sought.

According to the invention there is provided a multilayer food tray assembly suitable for use in an air fryer wherein the food tray assembly comprises two or more food trays and a frame wherein the frame provides a tray support wherein each tray has a lip for mounting on a tray support wherein at least one tray is a narrow tray which is narrower than the frame whereby a ventilation slot is formed between the narrow tray and the frame.

Advantages of the food tray assembly include that the multilayer food tray assembly enables separation of different types of ingredients into each food tray, achieving independent food textures and even cooking. Use of multiple layers allows the food tray assembly to be compact. The air flow created by the spaces between the trays and the frame ensures that the circulating hot air in an air fryer circulates through the food tray assembly, cooking its contents.

In some embodiments, the frame and/or the trays may be formed from a mouldable material. In some embodiments, the frame and/or the trays may be formed from a conductive material. In some embodiments, the frame and/or the trays may be formed from a mouldable conductive material. In some embodiments, the frame and/or the trays may be formed from a metal. In some embodiments, the frame and/or the trays may be formed from tin and/or aluminium.

In some embodiments, the frame may be formed from a heat resistant plastics or fibrous material. In some embodiments, the heat resistant plastics material may be polypropylene and/or polyethylene terephthalate. In some embodiments, the heat resistant fibrous material may comprise natural or synthetic material. In some embodiments, the heat resistant natural fibrous material may comprise cellulosic fibre (such as straw, grass, paper, wood, flax, cotton, jute, sisal, manila, hemp, and/or bamboo fibre).

In some embodiments, the frame may comprise a frame base and a frame wall. In some embodiments, the frame wall may be formed from a plurality of wall segments. In some embodiments, a layer of the assembly may comprise a frame wall segment. In some embodiments, a layer of the assembly may comprise a frame wall segment and one or more trays. In some embodiments, a layer of the assembly may comprise a frame wall segment and one or two trays. In some embodiments, the assembly may comprise a base layer and one or more upper layers and the frame wall may comprise a lower wall segment and an upper wall segment for each upper layer.

In some embodiments, the frame wall may be a tapered frame wall. In some embodiments, the frame wall may be a tapered frame wall where the tapered frame wall has a top and a base where the length and width of the top of the tapered frame wall is greater than the length and width of the base of the tapering frame wall. In some embodiments, where the frame wall is a tapered frame wall comprising a plurality of wall segments, each wall segment may be a tapered wall segment. In some embodiments, each tapered wall segment below the uppermost wall segment may have a wall length and wall width which are less than the wall length and wall width of the wall segment above it. In some embodiments, where the frame wall is a tapered frame wall comprising a plurality of wall segments, the trays may be tapered trays which are each dimensioned to engage with a frame support on each corresponding wall segment.

In some embodiments, each tapered tray below the uppermost tray may have a wall length and wall width which are less than the wall length and wall width of the tray above it. In some embodiments, the frame wall may be a stepped tapered frame wall comprising a plurality of tapered wall segments where the tray supports may comprise an upper tray support formed by the uppermost tapered wall segment and one or more lower tray supports which are each step-shaped lower tray supports formed between tapered wall segments. In some embodiments, the upper tray support may be in the form of a lip around the uppermost wall segment.

In some embodiments, each tray may comprise a tray base and a tray wall. In some embodiments, the lip of each tray may be formed on an upper end of the tray wall. In some embodiments, the frame base and/or a tray base may form a plurality of dimples for receiving oil, fat, or liquid formed during cooking. In some embodiments, where each layer may comprise a wall segment and one or more trays which each comprises a tray wall, the tray wall may have a height which is less than a height of the wall segment such that a ventilation gap is formed below the tray.

In some embodiments, the one or more narrow trays may form one or more ventilation slots where each ventilation slot is formed between a ventilation side of the tray and the frame. In some embodiments, the ventilation slots may be opposed ventilation slots which are formed on opposite sides of the tray where each ventilation slot is formed between a ventilation side of the tray and the frame. In some embodiments, the tray may form one or two ventilation slots where each ventilation slot is formed between a ventilation side of the tray and the frame.

In some embodiments, the one or more narrow trays may have one or more tabs for spacing the one or more narrow trays from the frame. In some embodiments, the one or more tabs may be formed by the tray lip. In some embodiments, the one or more tabs space the one or more narrow trays from the frame to form a ventilation slot.

In some embodiments, the assembly may comprise a base layer and one or more upper layers. In some embodiments, a layer of the assembly may comprise one or more trays. In some embodiments, a layer of the assembly may comprise one or two trays. In some embodiments, where a layer comprises one tray, the tray may form one or two ventilation slots where each ventilation slot is formed between a ventilation side of the tray and a wall of the frame. In some embodiments, where a layer comprises two trays, the tray may form one or two ventilation slots where each ventilation slot is formed between a ventilation side of the tray and a wall of the frame. In some embodiments, where a layer comprises two trays, the tray may form one ventilation slot between a ventilation side of the tray and a wall of the frame.

In some embodiments, the ventilation slot may allow air flow through the food tray assembly. In some embodiments, the ventilation slot may allow the tray to be gripped. An advantage of the ventilation slot being dimensioned to allow the tray to be gripped (e.g. by finger tips) is that it allows the tray to be easily removed from the frame without spilling its contents.

The invention will now be illustrated with reference to the following Figures of the accompanying drawings which are not intended to limit the scope of the claimed invention:

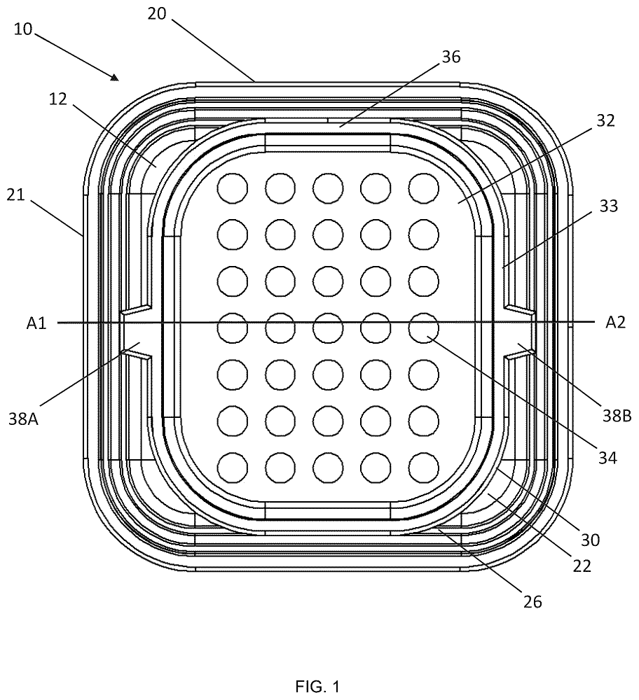

FIG. 1 shows a schematic plan view of a partial multilayer food tray assembly according to a first embodiment of the invention which comprises a frame and one food tray;

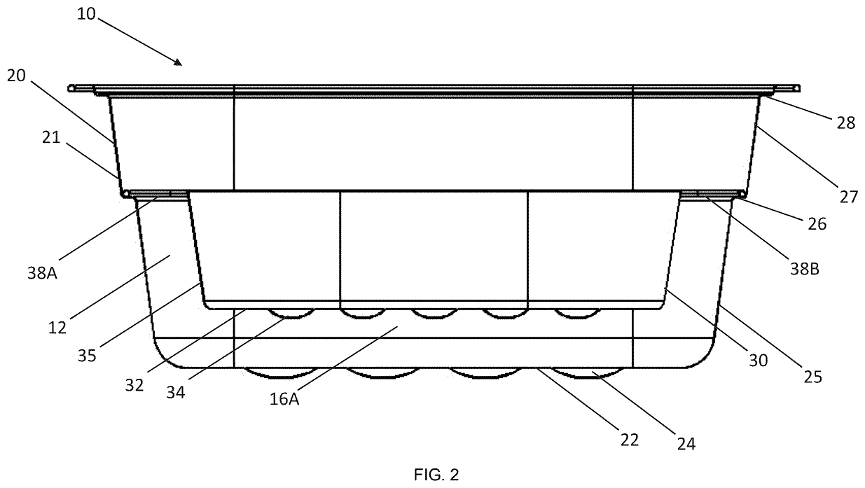

FIG. 2 shows a schematic vertical cross-sectional view of a partial multilayer food tray assembly according to a first embodiment of the invention which comprises a frame and one food tray (where the vertical cross-section is obtained using a vertical intersecting plane defined by axis A1-A2 on FIG. 1 where the vertical intersecting plane is perpendicular to the base of the food tray assembly);

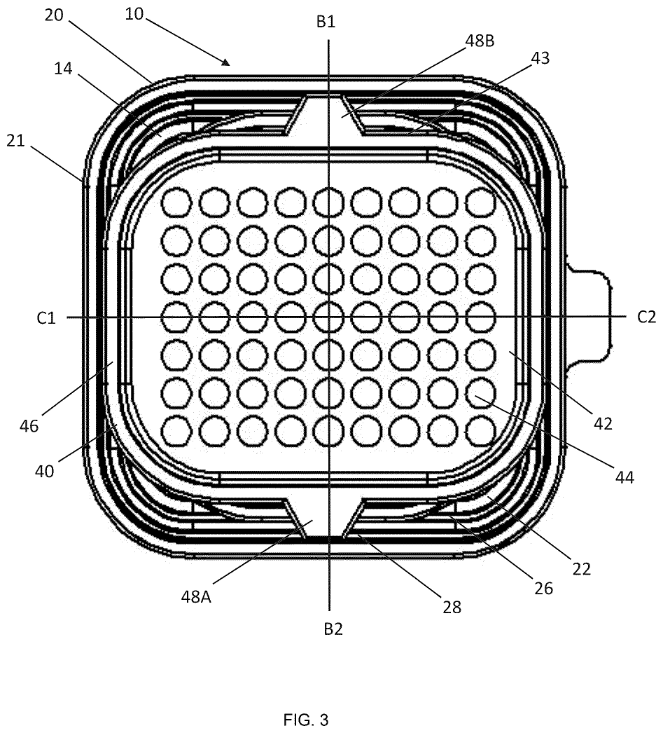

FIG. 3 shows a schematic plan view of the multilayer food tray assembly according to the first embodiment of the invention which comprises a frame and two food trays;

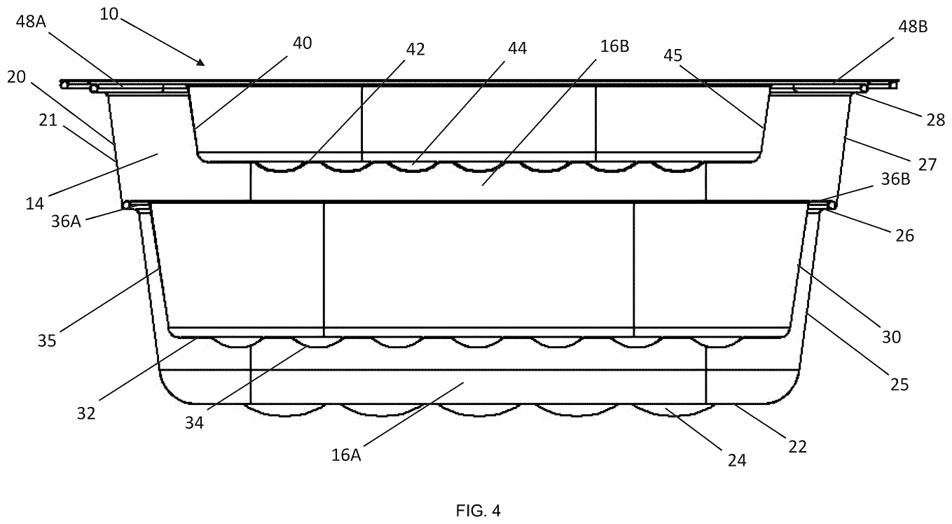

FIG. 4 shows a schematic first vertical cross-sectional view of the multilayer food tray assembly according to the first embodiment of the invention which comprises a frame and two food trays (where the vertical cross-section is obtained using a vertical intersecting plane defined by axis B1-B2 on FIG. 3 where the vertical intersecting plane is perpendicular to the base of the food tray assembly);

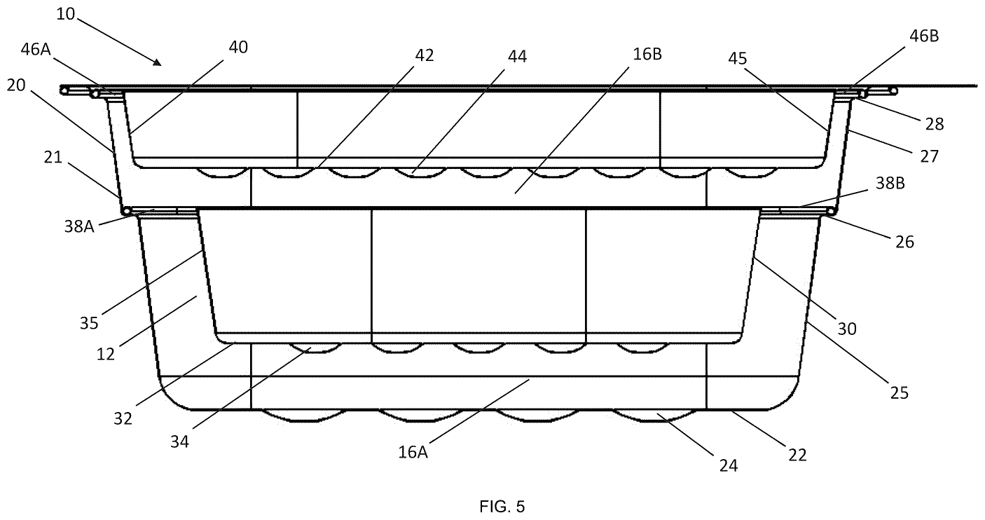

FIG. 5 shows a schematic second vertical cross-sectional view of the multilayer food tray assembly according to the first embodiment of the invention which comprises a frame and two food trays (where the vertical cross-section is obtained using a vertical intersecting plane defined by axis C1-C2 on FIG. 3 where the vertical intersecting plane is perpendicular to the base of the food tray assembly);

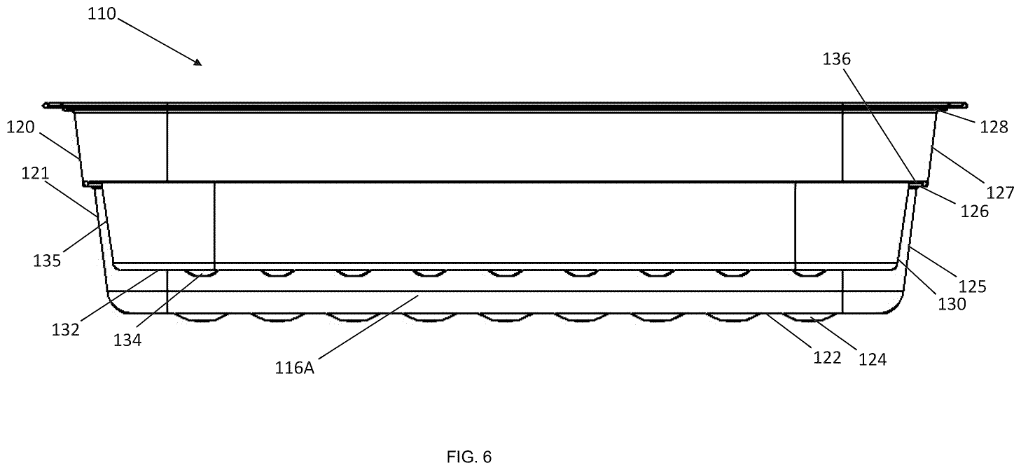

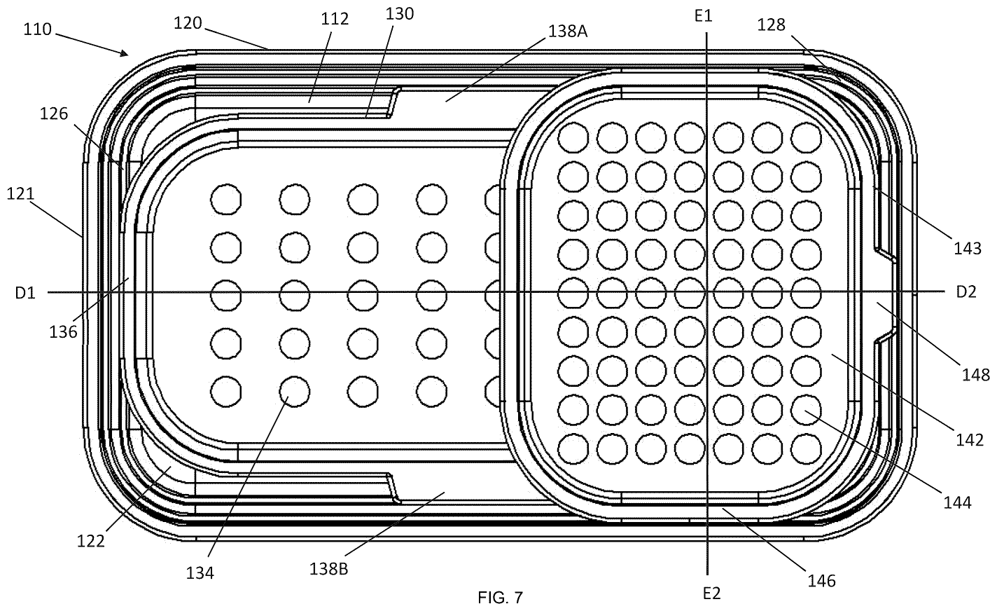

FIG. 6 shows a schematic vertical cross-sectional view of a first partial multilayer food tray assembly according to a second embodiment of the invention which comprises a frame and one food tray (where the vertical cross-section is obtained using a vertical intersecting plane defined by axis D1-D2 on FIG. 7 where the vertical intersecting plane is perpendicular to the base of the food tray assembly);

FIG. 7 shows a schematic plan view of a second partial multilayer food tray assembly according to the second embodiment of the invention which comprises a frame and two food trays;

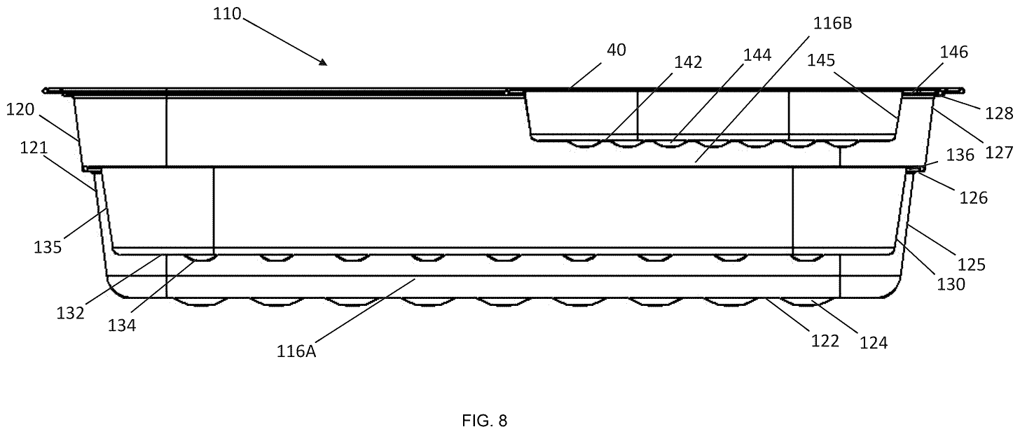

FIG. 8 shows a schematic first vertical cross-sectional view of the second partial multilayer food tray assembly according to the second embodiment of the invention which comprises a frame and two food trays (where the vertical cross-section is obtained using a vertical intersecting plane defined by axis D1-D2 on FIG. 7 where the vertical intersecting plane is perpendicular to the base of the food tray assembly);

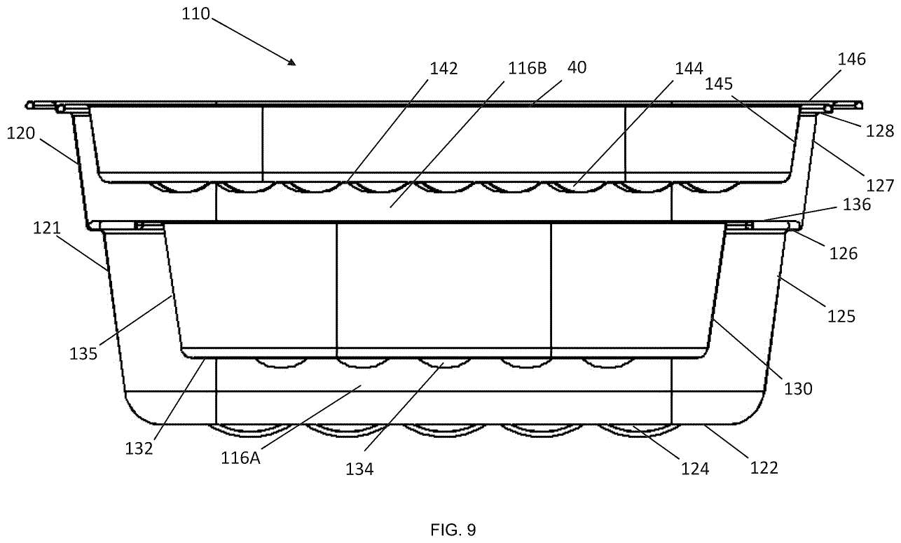

FIG. 9 shows a schematic second vertical cross-sectional view of the second partial multilayer food tray assembly according to the second embodiment of the invention which comprises a frame and two food trays (where the vertical cross-section is obtained using a vertical intersecting plane defined by axis E1-E2 on FIG. 7 where the vertical intersecting plane is perpendicular to the base of the food tray assembly); and

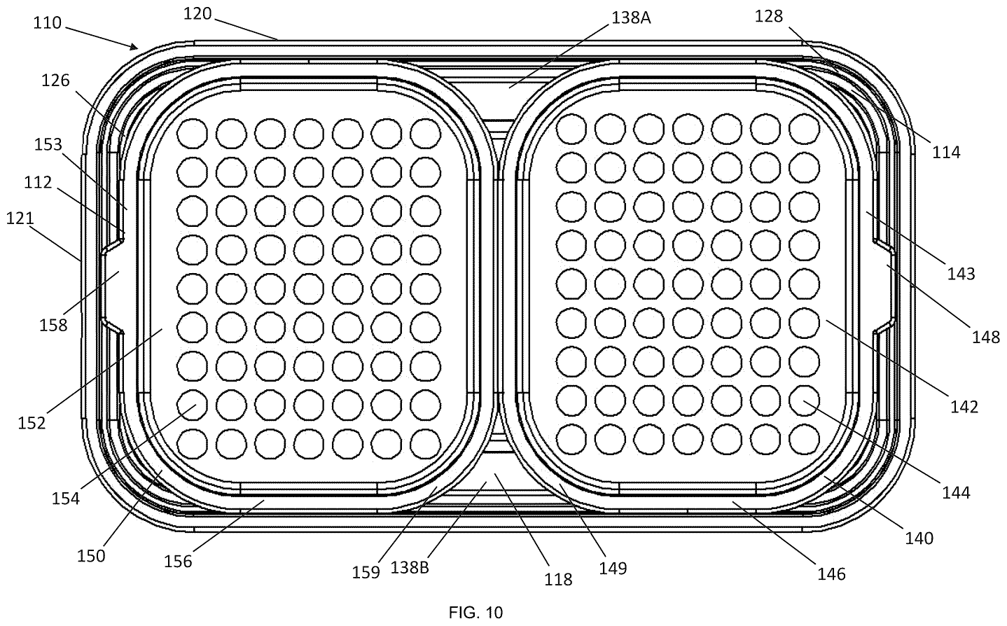

FIG. 10 shows a schematic plan view of the multilayer food tray assembly according to the second embodiment of the invention which comprises a frame and three food trays.

A multilayer food tray assembly according to a first embodiment of the invention is indicated generally at 10 on FIGS. 1 to 5 of the accompanying drawings. The multilayer food tray assembly 10 comprises a frame 20 and two layers which are formed by a lower narrow tray 30, and an upper narrow tray 40. The lower narrow tray 30 and upper narrow tray 40 are referred to as narrow trays 30,40 as their width and length are less than the width and length of the frame 20, respectively. As a result, the narrow trays 30,40 are narrower than the frame 20 such that ventilation slots 12,14 are formed between the ventilation sides 33,43 of the narrow trays 30,40 and the frame 20.

The frame 20, lower narrow tray 30, and upper narrow tray 40 are formed from moulded aluminium foil. In an alternative embodiment, frame 20, lower narrow tray 30, and upper narrow tray 40 may be formed from a different mouldable metal sheet such as tin. Advantages of using a metal such as aluminium or tin include that the food tray assembly is easier to heat.

In a further alternative embodiment, the frame 20 may be formed from a heat resistant plastics material such as polypropylene or polyethylene terephthalate where the frame 20 supports a lower narrow tray 30 and two or more stacked upper trays 40A,40B (not shown) such that the food tray assembly has at least three layers of food trays. Advantages of using a heat resistant plastics material to form frame 20 include that a plastics material may support two or more upper trays 40A,40B. Theoretically, it would be possible to construct frame 20 from metal such that it may support two or more upper trays 40A,40B but the cost/weight of such a frame 20 would be impractical for this usage.

Frame 20 comprises a frame base 22 and a frame wall 21. Frame wall 21 comprises a lower wall segment 25, and an upper wall segment 27. The frame base 22 forms a plurality of frame base dimples 24 for receiving fats and/oils while food in the trays 30,40 is cooking. Between the lower wall segment 25 and the upper wall segment 27, a lower tray support 26 is formed. Frame wall 21 is a tapered frame wall 21 as the upper wall segment 27 has a longer length and width than those for the lower wall segment 25. The step-shaped lower tray support 26 is formed as a horizontal ledge between the lower wall segment 25 and the upper wall segment 27. Upper wall segment 27 forms a horizontal lip around its upper edge which acts as upper tray support 28. Frame 20 has a square horizontal cross-sectional shape (where the horizontal cross-section is obtained using an intersecting plane which is parallel to the base 22 of the frame 20).

Lower narrow tray 30 comprises a lower tray base 32, a lower tray wall 35 which forms an enclosure or a container for food to be placed in the lower narrow tray 30, and a lower tray lip 36 which is formed around the outer periphery of the top of lower tray wall 35. Lower tray wall 35 has a height which is less than the height of the lower wall segment 25 such that a lower ventilation gap 16A is formed below lower narrow tray 30.

Lower narrow tray 30 has a rectangular horizontal cross-sectional shape. On each long side 33 of the lower narrow tray 30, lower tray lip 36 forms a lower tray tab 38A,38B. Lower tray tabs 38A,38B are opposed and equidistant from each end of the long side 33 of the lower narrow tray 30. Lower tray tabs 38A,38B are shaped to rest on the lower tray support 26 such that the lower tray tabs 38A,38B space the lower narrow tray 30 from the frame wall 21 and that lower ventilation slots 12 are formed to each side of the lower tray tabs 38A,38B between each long side 33 of the lower narrow tray 30 and the frame lower wall segment 25. As well as providing ventilation, the lower ventilation slots 12 allow the lower tray lip 36 to be gripped for easy removal of the lower narrow tray 30 from the frame 20 without spilling its contents. Long sides 33 of the lower narrow tray 30 are referred to herein as the ventilation sides 33 of the lower narrow tray 30: the lower ventilation slots 12 are formed between the ventilation sides 33 and the frame wall 21.

Upper narrow tray 40 comprises an upper tray base 42, an upper tray wall 45 which forms an enclosure or a container for food to be placed in the upper narrow tray 40, and an upper tray lip 46 which is formed around the outer periphery of the top of upper tray wall 45. Upper tray wall 45 has a height which is less than the height of the upper wall segment 27 such that an upper ventilation gap 16B is formed below upper narrow tray 40 and lower narrow tray 30.

Upper narrow tray 40 has a rectangular horizontal cross-sectional shape. On each long side 43 of the upper narrow tray 40, upper tray lip 46 forms an upper tray tab 48A,48B. Upper tray tabs 48A,48B are opposed and equidistant from each end of the long side 43 of the upper narrow tray 40. Upper tray tabs 48A,48B are shaped to rest on the upper tray support 28 such that the upper tray tabs 48A,48B space the upper narrow tray 40 from the frame wall 21 and that upper ventilation slots 14 are formed to each side of the upper tray tabs 48A,48B between each long side 43 of the upper narrow tray 40 and the frame upper wall segment 27. As well as providing ventilation, the upper ventilation slots 14 allow the upper tray lip 46 to be gripped for easy removal of the upper narrow tray 40 from the frame 20 without spilling its contents. Long sides 43 of the upper narrow tray 40 are referred to herein as the ventilation sides 43 of the upper narrow tray 40: the upper ventilation slots 14 are formed between the ventilation sides 43 and the frame wall 21.

Upper narrow tray 40 is rotated 90° relative to the lower narrow tray 30 such that the upper ventilation slot 14 is perpendicular to the lower ventilation slot 12 for improved air circulation through the food tray assembly 10.

A multilayer food tray assembly according to a second embodiment of the invention is indicated generally at 110 on FIGS. 6 to 10 of the accompanying drawings. The multilayer food tray assembly 110 comprises a frame 120 and two layers which are formed by a lower narrow tray 130 and by two upper narrow trays 140,150 which comprise a first upper narrow tray 140 and a second upper narrow tray 150. Like features of the second embodiment to the features of the first embodiment are identified by like reference numbers except that reference numerals for the second embodiment are prefixed with the numeral “1”. The lower narrow tray 130 and upper narrow trays 140,150 are referred to as narrow trays 130,140,150 as their width and lengths are less than the width and length of the frame 120, respectively. As a result, the narrow trays 130,140,150 are narrower than the frame 120 such that ventilation slots 112,114 are formed between the ventilation sides 133,143 of the narrow trays 130,140 and the frame 120.

As for the first embodiment, frame 120 is formed from moulded aluminium foil. In an alternative embodiment, frame 120 may be formed from a different mouldable metal sheet such as tin or from a heat resistant plastics material for similar reasons for the multilayer food tray assembly 10 according to the first embodiment of the invention.

Frame 120 comprises a frame base 122 and a frame wall 121. Frame wall 121 comprises a lower wall segment 125, and an upper wall segment 127. The frame base 122 forms a plurality of frame base dimples 124 for receiving fats and/oils while food in the trays 130,140,150 is cooking. Between the lower wall segment 125 and the upper wall segment 127, a lower tray support 126 is formed. Frame wall 121 is a tapered frame wall 121 as the upper wall segment 127 has a longer length and width than those for the lower wall segment 125. The step-shaped lower tray support 126 is formed as a horizontal ledge between the lower wall segment 125 and the upper wall segment 127. Upper wall segment 127 forms a horizontal lip around its upper edge which acts as upper tray support 128. Frame 120 has a rectangular horizontal cross-sectional shape (where the horizontal cross-section is obtained using an intersecting plane which is parallel to the base 122 of the frame 120).

Lower narrow tray 130 comprises a lower tray base 132, a lower tray wall 135 which forms an enclosure or a container for food to be placed in the lower narrow tray 130, and a lower tray lip 136 which is formed around the outer periphery of the top of lower tray wall 135. Lower tray wall 135 has a height which is less than the height of the lower wall segment 125 such that a lower ventilation gap 116A is formed below lower narrow tray 130.

Lower narrow tray 130 has a rectangular horizontal cross-sectional shape. On each long side 133 of the lower narrow tray 130, lower tray lip 136 forms a lower tray tab 138A, 138B. Lower tray tabs 138A,138B are opposed and equidistant from each end of the long side 133 of the lower narrow tray 130. Lower tray tabs 138A, 138B are shaped to rest on the lower tray support 126 such that the lower tray tabs 138A, 138B space the lower narrow tray 130 from the frame wall 121 and that a lower ventilation slot 112 is formed between each long side 133 of the lower narrow tray 130 and the frame lower wall segment 125. As well as providing ventilation, the lower ventilation slots 112 allow the lower tray lip 136 to be gripped for easy removal of the lower narrow tray 130 from the frame 120 without spilling its contents. Long sides 133 of the lower narrow tray 130 are referred to herein as the ventilation sides 133 of the lower narrow tray 130 as the lower ventilation slots 112 are formed between the ventilation sides 133 and the frame wall 121.

First upper narrow tray 140 comprises an upper tray base 142, an upper tray wall 145 which forms an enclosure or a container for food to be placed in the first upper narrow tray 140, and an upper tray lip 146 which is formed around the outer periphery of the top of upper tray wall 145. The upper tray wall 145 and upper tray lip 146 forms rounded corners 149. First upper narrow tray 140 has a rectangular horizontal cross-sectional shape. On one long side 143 of the first upper narrow tray 140, upper tray lip 146 forms an upper tray tab 148. Upper tray tab 148 is equidistant from each end of the long side 143 of the first upper narrow tray 140. Upper tray tab 148 is shaped to rest on the upper tray support 28 such that the upper tray tab 148 spaces the first upper narrow tray 140 from the frame wall 121 and that a first upper ventilation slot 114 is formed between the long side 143 of the first upper narrow tray 140 and the frame upper wall segment 127. As well as providing ventilation, the first upper ventilation slot 114 allows the long side 143 of the upper tray lip 146 to be gripped for easy removal of the upper narrow tray 140 from the frame 120 without spilling its contents. Long side 143 of the upper narrow tray 140 is referred to herein as the ventilation side 143 of the upper narrow tray 140 as the first upper ventilation slot 114 is formed between the ventilation side 143 and the frame wall 121.

Second upper narrow tray 150 comprises an upper tray base 152, an upper tray wall 155 which forms an enclosure or a container for food to be placed in the second upper narrow tray 150, and an upper tray lip 156 which is formed around the outer periphery of the top of upper tray wall 155. The upper tray wall 155 and upper tray lip 156 forms rounded corners 159. Second upper narrow tray 150 has a rectangular horizontal cross-sectional shape. On one long side 153 of the second upper narrow tray 150, upper tray lip 156 forms an upper tray tab 158. Upper tray tab 158 is equidistant from each end of the long side 153 of the second upper narrow tray 150. Upper tray tab 158 is shaped to rest on the upper tray support 28 such that the upper tray tab 158 spaces the second upper narrow tray 150 from the frame wall 121 and that a first upper ventilation slot 114 is formed between the long side 153 of the second upper narrow tray 150 and the frame upper wall segment 127. As well as providing ventilation, the upper ventilation slot 114 allows the long side 153 of the upper tray lip 156 to be gripped for easy removal of the second upper narrow tray 150 from the frame 120 without spilling its contents. Long side 153 of the second upper narrow tray 150 is referred to herein as the ventilation side 153 of the upper narrow tray 150 as the upper ventilation slot 114 is formed between the ventilation side 153 and the frame wall 121.

Second upper ventilation slots 118 are formed between the upper trays 140,150. The second upper ventilation slots 118 are formed between the rounded corners 149,159 of the upper trays 140,150. Due to the shape of the rounded corners 149,159, a substantial gap is formed between the upper trays 140,150 which provides additional ventilation.

The long sides 143,153 of upper trays 140,150 are perpendicular to the long side of lower narrow tray 130 such that upper ventilation slot 114 is not vertically above lower ventilation slot 112 for improved air circulation through the food tray assembly 110. Furthermore, the second upper ventilation slots 118 are formed vertically above the lower tray tabs 138A,138B for further increased air circulation through the food assembly 110.

What is claimed is:

1. A multilayer food tray assembly suitable for use in an air fryer wherein the food tray assembly comprises two or more food trays and a frame wherein the frame provides a tray support wherein each tray has a lip for mounting on a tray support wherein at least one tray is a narrow tray which is narrower than the frame whereby a ventilation slot is formed between the narrow tray and the frame.

2. The multilayer food tray assembly as defined in claim 1 where the frame and/or the trays are formed from a conductive material.

3. The multilayer food tray assembly as defined in claim 1 wherein the frame is formed from a heat resistant plastics or fibrous material.

4. The multilayer food tray assembly as defined in claim 1 wherein the frame comprises a frame base and a frame wall.

5. The multilayer food tray assembly as defined in claim 4 wherein the frame wall comprises a plurality of wall segments.

6. The multilayer food tray assembly as defined in claim 4 wherein a layer comprises a frame wall segment.

7. The multilayer food tray assembly as defined in claim 4 wherein a layer comprises a frame wall segment and one or more trays.

8. The multilayer food tray assembly as defined in claim 4 which comprises a base layer and one or more upper layers and the frame wall comprises a lower wall segment and an upper wall segment for each upper layer.

9. The multilayer food tray assembly as defined in claim 4 wherein the frame wall is a tapered frame wall.

10. The multilayer food tray assembly as defined in claim 9 wherein the tapered frame wall comprises a plurality of tapered wall segments.

11. The multilayer food tray assembly as defined in claim 9 wherein the two or more food trays are tapered food trays.

12. The multilayer food tray assembly as defined in claim 9 wherein the tapered frame wall is a stepped tapered frame wall which comprises a plurality of tapered wall segments wherein the tray supports comprise an upper tray support and one or more lower tray supports which are each step-shaped lower tray supports formed between tapered wall segments.

13. The multilayer food tray assembly as defined in claim 12 wherein the upper tray support comprises a lip around the uppermost wall segment.

14. The multilayer food tray assembly as defined in claim 1 wherein the one or more narrow trays have one or more tabs for spacing the or each narrow tray from the frame.

15. The multilayer food tray assembly as defined in claim 1 wherein the one or more narrow trays form one or more ventilation slots where each ventilation slot is formed between a ventilation side of the narrow tray and the frame.

16. The multilayer food tray assembly as defined in claim 1 which comprises a base layer and one or more upper layers.

17. The multilayer food tray assembly as defined in claim 16 wherein a layer comprises one or more trays, for example one or two trays.

18. The multilayer food tray assembly as defined in claim 1 wherein where a layer comprises one or two trays, each tray forms one or two ventilation slots where each ventilation slot is formed between a ventilation side of the tray and a wall of the frame.

19. The multilayer food tray assembly as defined in claim 1 wherein where a layer comprises two trays, each tray forms one ventilation slot between a ventilation side of the tray and a wall of the frame.

20. The multilayer food tray assembly as defined in claim 1 wherein each of the two or more food trays comprises a tray base and a tray wall.

21. The multilayer food tray assembly as defined in claim 1 wherein the lip of each tray is formed on an upper end of the tray wall.
